(19) United States
(12) Patent Application Publication
(10) Pub. No.: US 2024/0020030 A1
(43) Pub. Date: Jan. 18, 2024

(54) SYSTEM AND METHOD OF UTILIZING NONVOLATILE MEMORY MEDIA ASSOCIATED WITH AN INFORMATION HANDLING SYSTEM

(71) Applicant: Dell Products L.P., Round Rock, TX (US)

(72) Inventors: Vivek Sundaresan, Austin, TX (US); Shashi Kiran Belur, Yunlin (IN); Ashokan Vellimalai, Round Rock, TX (US)

(21) Appl. No.: 17/812,481

(22) Filed: Jul. 14, 2022

(51) Int. Cl. G06F 3/06

(52) U.S. Cl. CPC G06F 3/0631; G06F 3/0619; G06F 3/0689

(57) ABSTRACT

In one or more embodiments, one or more systems, one or more methods, and/or one or more processes may: determine that a first nonvolatile memory medium of a first redundant array of independent disks (RAID) is not operable to be utilized in the first RAID; access, via another RAID controller, an amount of data storage of a second nonvolatile memory medium of a second RAID that is operable to be utilized in the first RAID; rebuild the first RAID with the amount of data storage of the second nonvolatile memory medium; receive file information from an operating system to store via the first RAID; store, via the other RAID controller, at least a first portion of the file information to the second nonvolatile memory medium; receive the at least the first portion of the file information from the other RAID controller; and provide the file information to the operating system.

### BACKGROUND

### Field of the Disclosure

This disclosure relates generally to information handling systems and more particularly to utilizing nonvolatile memory media associated with an information handling system.

### Description of the Related Art

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

### SUMMARY

In one or more embodiments, one or more systems, one or more methods, and/or one or more processes may determine, by a first redundant array of independent disks (RAID) controller, that a first nonvolatile memory medium of a first RAID is not operable to be utilized in the first RAID; may determine, by a second RAID controller, that at least one of nonvolatile memory medium of a second RAID has an amount of data storage that is operable to be utilized in the first RAID; may allocate, by the second RAID controller, the amount of data storage that is operable to be utilized in the first RAID from the at least one of the nonvolatile memory medium of the second RAID; may provide, by the second RAID controller, access to the amount of data storage of the at least one of the nonvolatile memory medium of the second RAID to the first RAID controller via a Peripheral Component Interconnect Express (PCIe) protocol; may rebuild, by the first RAID controller, the first RAID with the amount of data storage of the at least one of the nonvolatile memory medium of the second RAID; may receive, by the first RAID controller, file information from an operating system to store via the first RAID; may provide, by the first RAID controller, at least a first portion of the file information to the second RAID controller via the PCIe protocol; may store, by the second RAID controller, the at least the first portion of the file information via the at least one of the nonvolatile memory medium of the second RAID; may receive, by the first RAID controller, the at least the first portion of the file information from the second RAID controller via the PCIe protocol; and may provide, by the first RAID controller, the file information to the operating system.

In one or more embodiments, the one or more systems, the one or more methods, and/or the one or more processes may further provide, by the second RAID controller, the at least the first portion of the file information to the first RAID controller via the PCIe protocol. In one or more embodiments, the one or more systems, the one or more methods, and/or the one or more processes may further receive, by the first RAID controller, a request for the file information from the operating system. In one or more embodiments, providing the access to the amount of data storage of the at least one of nonvolatile memory medium of the second RAID to the first RAID controller via the PCIe protocol may include providing a virtual drive to the first RAID controller via the PCIe protocol.

In one or more embodiments, the PCIe protocol may encapsulate a vendor defined message protocol. For example, providing the access to the amount of data storage of the at least one of nonvolatile memory medium to the first RAID controller via the PCIe protocol includes providing the access to the amount of data storage of the at least one of nonvolatile memory medium to the first RAID controller via the vendor defined message protocol. In one or more embodiments, the one or more systems, the one or more methods, and/or the one or more processes may further: determine, by the first RAID controller, that a third nonvolatile memory medium has been added to the first RAID; rebuild the first RAID with the third nonvolatile memory medium; and provide, by the first RAID controller, deallocation information to the second RAID controller via the PCIe protocol to indicate that the amount of data storage is no longer needed.

In one or more embodiments, the at least one of nonvolatile memory medium of the second RAID may include multiple of nonvolatile memory media. For example, the one or more systems, the one or more methods, and/or the one or more processes may further: determine, by the second RAID controller, that a first nonvolatile memory medium of the multiple nonvolatile memory media includes a first portion of the amount of data storage that is operable to be utilized in the first RAID; determine, by the second RAID controller, that a second nonvolatile memory medium of the multiple nonvolatile memory media includes a second portion of the amount of data storage that is operable to be utilized in the first RAID; allocate, by the second RAID controller, the first portion of the amount of data storage that is operable to be utilized in the first RAID from the first nonvolatile memory medium of the multiple nonvolatile memory media; allocate, by the second RAID controller, the second portion of the amount of data storage that is operable to be utilized in the first RAID from the second nonvolatile memory medium of the multiple nonvolatile memory media; and provide, by the second RAID controller via the PCIe protocol, access to the amount of data storage that is operable to be utilized in the first RAID via a combination of portions of the amount of data storage that is operable to be utilized in the first RAID that includes the first portion of the amount of data storage that is operable to be utilized in the first RAID and the second portion of the amount of data storage that is operable to be utilized in the first RAID. For instance, rebuilding the first RAID with the amount of data storage of the at least one of nonvolatile memory media of the second RAID may include rebuilding the first RAID with the combination of portions of the amount of data storage that is operable to be utilized in the first RAID.

In one or more embodiments, storing, by the second RAID controller, the at least the first portion of the file information via the at least one of the nonvolatile memory medium of the second RAID may include the storing the at least the first portion of the file information via the first portion of the amount of data storage that is operable to be utilized in the first RAID; and receiving, by the first RAID controller, the at least the first portion of the file information from the second RAID controller via the PCIe protocol may include receiving the at least the first portion of the file information from the second RAID controller from the first portion of the amount of data storage. For example, the one or more systems, the one or more methods, and/or the one or more processes may further: provide, by the first RAID controller, at least a second portion of the file information to the second RAID controller via the PCIe protocol; store, by the second RAID controller, the at least the second portion of the file information via the second portion of the amount of data storage that is operable to be utilized in the first RAID; and receive, by the first RAID controller via the PCIe protocol, the at least the second portion of the file information from the second RAID controller from the second portion of the amount of data storage.

In one or more embodiments, a RAID controller, configured to: determine that a first nonvolatile memory medium of a first RAID is not operable to be utilized in the first RAID; provide, to another RAID controller via a PCIe protocol, a request for at least a second nonvolatile memory medium of a second RAID has a amount of data storage that is operable to be utilized in the first RAID; access, via the PCIe protocol and the other RAID controller, the amount of data storage of the second nonvolatile memory medium; rebuild the first RAID with the amount of data storage of the second nonvolatile memory medium; receive file information from an operating system to store via the first RAID; store, via the PCIe protocol and the other RAID controller, at least a first portion of the file information to the second nonvolatile memory medium; receive the at least the first portion of the file information from the other RAID controller via the PCIe protocol; and provide the file information to the operating system.

In one or more embodiments, the PCIe protocol may encapsulate a vendor defined message protocol. For example, receiving the at least the first portion of the file information from the other RAID controller via the PCIe protocol may include receiving the at least the first portion of the file information from the other RAID controller via the vendor defined message protocol. In one or more embodiments, the RAID controller may be further configured to: determine that a third nonvolatile memory medium has been added to the first RAID; rebuild the first RAID with the third nonvolatile memory medium; and provide deallocation information to the other RAID controller via the PCIe protocol to indicate that the amount of data storage is no longer needed. In one or more embodiments, the RAID controller may be further configured to recognize, via the PCIe protocol, the amount of data storage from the other RAID controller as a virtual drive.

### BRIEF DESCRIPTION OF THE DRAWINGS

For a more complete understanding of the present disclosure and its features/advantages, reference is now made to the following description, taken in conjunction with the accompanying drawings, which are not drawn to scale, and in which:

FIGS. 1A-1C illustrate examples of information handling systems, according to one or more embodiments;

FIG. 2 illustrates an example of a baseboard management controller, according to one or more embodiments;

FIG. 3A illustrates an example of a redundant array of independent disks (RAID) controller, according to one or more embodiments;

FIG. 3B illustrates another example of a RAID controller, according to one or more embodiments;

FIGS. 4A-4C illustrates an example of a sequence diagram of operating an information handling system is illustrated, according to one or more embodiments;

FIG. 5A illustrates an example of a method of operating an information handling system, according to one or more embodiments;

FIG. 5B illustrates an example of application programming interface calls, according to one or more embodiments;

FIGS. 6A and 6B illustrate an example of a method of operating RAID controllers, according to one or more embodiments;

FIG. 7A illustrates an example of an amount of data storage of a drive, according to one or more embodiments;

FIG. 7B illustrates an example of an amount of data storage of multiple portions of respective multiple drives, according to one or more embodiments; and

FIG. 7C illustrates another example of an amount of data storage of multiple portions of respective multiple drives, according to one or more embodiments.

### DETAILED DESCRIPTION

In the following description, details are set forth by way of example to facilitate discussion of the disclosed subject matter. It should be apparent to a person of ordinary skill in the field, however, that the disclosed embodiments are examples and not exhaustive of all possible embodiments.

As used herein, a reference numeral refers to a class or type of entity, and any letter following such reference numeral refers to a specific instance of a particular entity of that class or type. Thus, for example, a hypothetical entity referenced by ‘12A’ may refer to a particular instance of a particular class/type, and the reference ‘12’ may refer to a collection of instances belonging to that particular class/type or any one instance of that class/type in general.

In one or more embodiments, one or more systems, one or more methods, and/or one or more processes may extend fault tolerance to system level and increase reusability of existing storage. In one or more embodiments, fault tolerance of a storage controller for a virtual drive may be based at least on a redundant array of independent disks (RAID) level. For example, if the storage controller (e.g., a RAID controller) does not have additional one or more physical drives available (e.g., one or more standby physical drives), if all available drives are used, or a number of drives are constrained due to hardware topology or controller topology, a physical drive from another RAID may be utilized. For instance, another storage controller associated with the other RAID may provide access to storage of the other RAID to the storage controller. As an example, the other storage controller may provide storage of the other RAID as a virtual drive to the storage controller.

In one or more embodiments, a RAID controller may include a type of storage hardware component that manages disk drives in a RAID infrastructure. For example, the RAID controller may provide physical disk drives as logical units to an information handling system managing the RAID infrastructure. For example, the RAID controller may provide grouped logical disk space to an operating system and/or applications executing on the information handling system. In one or more embodiments, a RAID controller may be called a disk array controller.

In one or more embodiments, a RAID controller may be classified based at least on one or more of a supported RAID level, a number of internal or external drive ports, a drive type, a number of drives the RAID controller can support, a front-end interface, a back-end interface, and a cache volatile memory medium, among others. In one example, a front-end interface of a RAID controller may enable communication with an information handling system host adapter. For instance, the front-end interface of a RAID controller may provide a logical drive to a processor and/or operating system of an information handling system. In another example, a back-end interface of a RAID controller may communicate and/or manage underlying drives.

In one or more embodiments, a RAID controller may implement a RAID level. For example, a RAID controller may implement a RAID level that is compliant with a Common RAID Disk Data Format Specification (available from the Storage Networking Industry Association). For instance, a RAID controller may implement one or more of a RAID level 0 (e.g., striping), RAID level 1 (e.g., mirroring), RAID level 5 (e.g., distributed parity), and RAID 6 (e.g., dual parity), among others. In one or more embodiments, multiple RAID levels may be combined or nested. For example, multiple RAID levels that may be combined or nested may include RAID level 10 (e.g., striping of mirrors) or RAID level 01 (e.g., mirroring stripe sets).

In one or more embodiments, a Peripheral Component Interconnect Express (PCIe) vendor defined message (VDM) technique and an application programming interface (API) may be implemented for one or more nonvolatile memory express (NVMe) devices, one or more storage controllers, and/or one or more RAIDs, among others. In one or more embodiments, a storage device may be associated with an endpoint identification (ID). For example, a RAID controller may be associated with an endpoint ID. In one or more embodiments, if a RAID controller has a need for storage space for a redundancy purpose, the RAID controller may instantiate an API call to all end point identifications (IDs). For example, a request for the storage space for the redundancy purpose may be fulfilled by a sequence of handshakes.

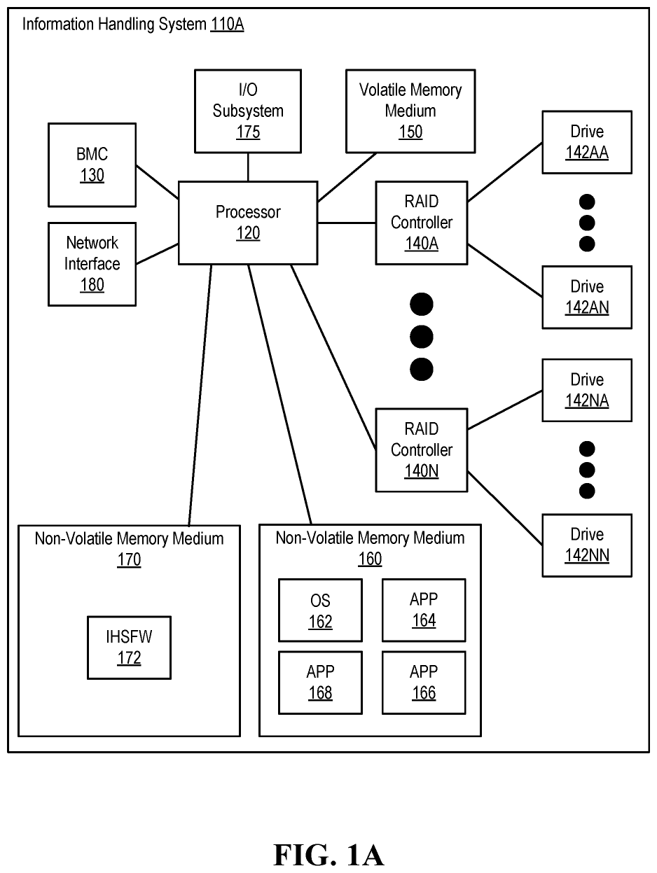

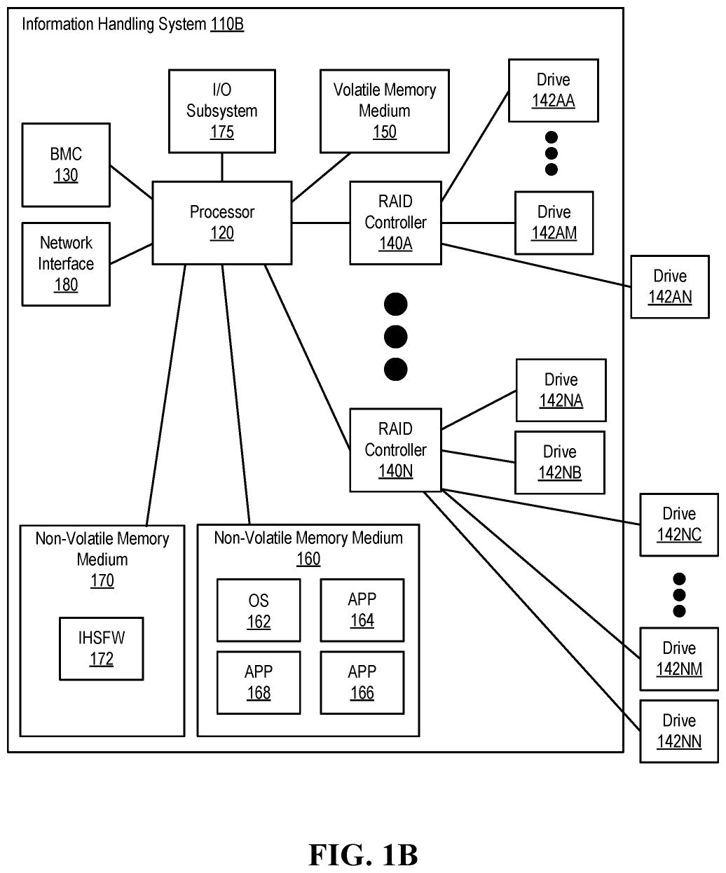

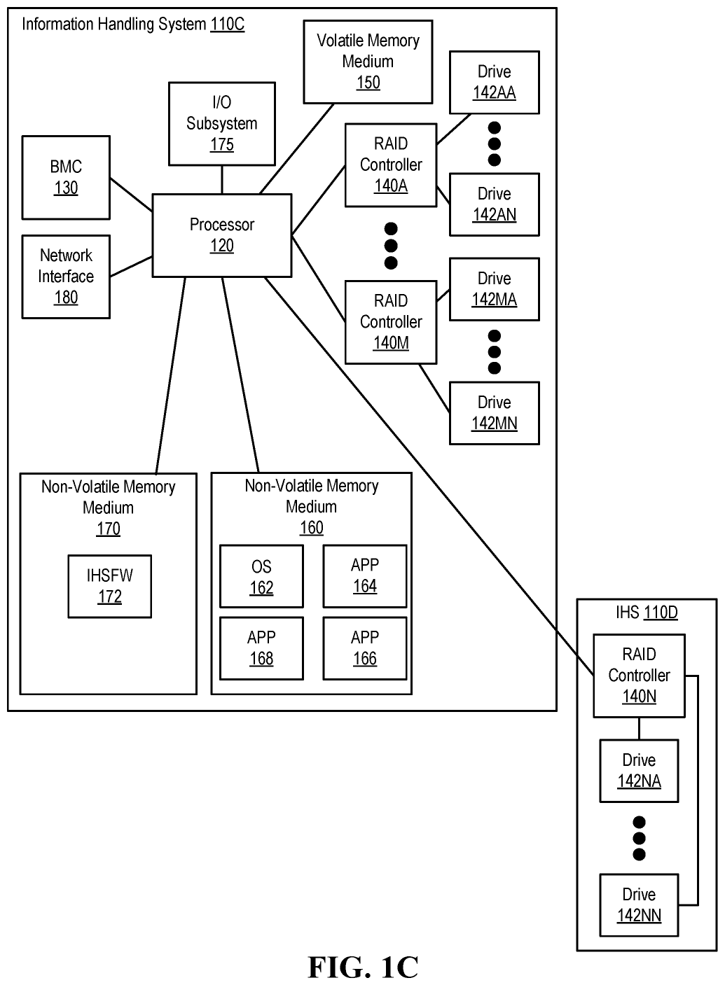

Turning now to FIGS. 1A-1C, examples of information handling systems are illustrated, according to one or more embodiments. An information handling system (IHS) 110 may include a hardware resource or an aggregate of hardware resources operable to compute, classify, process, transmit, receive, retrieve, originate, switch, store, display, manifest, detect, record, reproduce, handle, and/or utilize various forms of information, intelligence, or data for business, scientific, control, entertainment, or other purposes, according to one or more embodiments. For example, IHS 110 may be a personal computer, a desktop computer system, a laptop computer system, a server computer system, a mobile device, a tablet computing device, a personal digital assistant (PDA), a consumer electronic device, an electronic music player, an electronic camera, an electronic video player, a wireless access point, a network storage device, a RAID system, or another suitable device and may vary in size, shape, performance, functionality, and price. In one or more embodiments, a portable IHS 110 may include or have a form factor of that of or similar to one or more of a laptop, a notebook, a telephone, a tablet, and a PDA, among others. For example, a portable IHS 110 may be readily carried and/or transported by a user (e.g., a person). In one or more embodiments, components of IHS 110 may include one or more storage devices, one or more communications ports for communicating with external devices as well as various input and output (I/O) devices, such as a keyboard, a mouse, and a video display, among others. In one or more embodiments, IHS 110 may include one or more buses operable to transmit communication between or among two or more hardware components. In one example, a bus of IHS 110 may include one or more of a memory bus, a peripheral bus, and a local bus, among others. In another example, a bus of IHS 110 may include one or more of a Micro Channel Architecture (MCA) bus, an Industry Standard Architecture (ISA) bus, an Enhanced ISA (EISA) bus, a Peripheral Component Interconnect (PCI) bus, HyperTransport (HT) bus, an inter-integrated circuit (I²C) bus, a serial peripheral interface (SPI) bus, a low pin count (LPC) bus, an enhanced serial peripheral interface (eSPI) bus, a universal serial bus (USB), a system management bus (SMBus), and a Video Electronics Standards Association (VESA) local bus, among others.

In one or more embodiments, IHS 110 may include firmware that controls and/or communicates with one or more hard drives, network circuitry, one or more memory devices, one or more I/O devices, and/or one or more other peripheral devices. For example, firmware may include software embedded in an IHS component utilized to perform tasks. In one or more embodiments, firmware may be stored in non-volatile memory, such as storage that does not lose stored data upon loss of power. In one example, firmware associated with an IHS component may be stored in non-volatile memory that is accessible to one or more IHS components. In another example, firmware associated with an IHS component may be stored in non-volatile memory that may be dedicated to and includes part of that component. For instance, an embedded controller may include firmware that may be stored via non-volatile memory that may be dedicated to and includes part of the embedded controller.

In one or more embodiments, IHS 110 may include a processor 120, a baseboard management controller (BMC) 130, hardware RAID controllers 140A-140N, a volatile memory medium 150, non-volatile memory media 160 and 170, an I/O subsystem 175, and a network interface 180. For example, BMC 130, hardware RAID controllers 140A-140N, volatile memory medium 150, non-volatile memory media 160 and 170, I/O subsystem 175, and network interface 180 may be communicatively coupled to processor 120. In one or more embodiments, one or more of BMC 130, hardware RAID controllers 140A-140N, volatile memory medium 150, non-volatile memory media 160 and 170, I/O subsystem 175, and network interface 180 may be communicatively coupled to processor 120 via one or more buses, one or more switches, and/or one or more root complexes, among others. In one example, one or more of BMC 130, hardware RAID controllers 140A-140N, volatile memory medium 150, non-volatile memory media 160 and 170, I/O subsystem 175, and network interface 180 may be communicatively coupled to processor 120 via one or more PCIe root complexes. In another example, one or more of BMC 130, I/O subsystem 175 and network interface 180 may be communicatively coupled to processor 120 via one or more PCIe switches. Although not specifically illustrated, a RAID controller 140 may be communicatively coupled to BMC 130, according to one or more embodiments.

In one or more embodiments, the term “memory medium” may mean a “storage device”, a “memory”, a “memory device”, a “tangible computer readable storage medium”, and/or a “computer-readable medium”. For example, computer-readable media may include, without limitation, storage media such as a direct access storage device (e.g., a hard disk drive, a floppy disk, etc.), a sequential access storage device (e.g., a tape disk drive), a compact disk (CD), a CD-ROM, a digital versatile disc (DVD), a random access memory (RAM), a read-only memory (ROM), a one-time programmable (OTP) memory, an electrically erasable programmable read-only memory (EEPROM), and/or a flash memory, a solid state drive (SSD), or any combination of the foregoing, among others.

In one or more embodiments, one or more protocols may be utilized in transferring data to and/or from a memory medium. For example, the one or more protocols may include one or more of small computer system interface (SCSI), Serial Attached SCSI (SAS) or another transport that operates with the SCSI protocol, advanced technology attachment (ATA), serial ATA (SATA), a USB interface, an Institute of Electrical and Electronics Engineers (IEEE) 1394 interface, a Thunderbolt interface, an advanced technology attachment packet interface (ATAPI), serial storage architecture (SSA), integrated drive electronics (IDE), or any combination thereof, among others.

Volatile memory medium 150 may include volatile storage such as, for example, RAM, DRAM (dynamic RAM), EDO RAM (extended data out RAM), SRAM (static RAM), etc. One or more of non-volatile memory media 160 and 170 may include nonvolatile storage such as, for example, a read only memory (ROM), a programmable ROM (PROM), an erasable PROM (EPROM), an electrically erasable PROM, NVRAM (non-volatile RAM), ferroelectric RAM (FRAM), a magnetic medium (e.g., a hard drive, a floppy disk, a magnetic tape, etc.), optical storage (e.g., a CD, a DVD, a BLU-RAY disc, etc.), flash memory, a SSD, etc. In one or more embodiments, a memory medium can include one or more volatile storages and/or one or more nonvolatile storages.

In one or more embodiments, network interface 180 may be utilized in communicating with one or more networks and/or one or more other information handling systems. In one example, network interface 180 may enable IHS 110 to communicate via a network utilizing a suitable transmission protocol and/or standard. In a second example, network interface 180 may be coupled to a wired network. In a third example, network interface 180 may be coupled to an optical network. In another example, network interface 180 may be coupled to a wireless network. In one instance, the wireless network may include a cellular telephone network. In a second instance, the wireless network may include a satellite telephone network. In another instance, the wireless network may include a wireless Ethernet network (e.g., a Wi-Fi network, an IEEE 802.11 network, etc.).

In one or more embodiments, network interface 180 may be communicatively coupled via a network to a network storage resource. For example, the network may be implemented as, or may be a part of, a storage area network (SAN), personal area network (PAN), local area network (LAN), a metropolitan area network (MAN), a wide area network (WAN), a wireless local area network (WLAN), a virtual private network (VPN), an intranet, an Internet or another appropriate architecture or system that facilitates the communication of signals, data and/or messages (generally referred to as data). For instance, the network may transmit data utilizing a desired storage and/or communication protocol, including one or more of Fibre Channel, Frame Relay, Asynchronous Transfer Mode (ATM), Internet protocol (IP), other packet-based protocol, Internet SCSI (iSCSI), or any combination thereof, among others.

In one or more embodiments, processor 120 may execute processor instructions in implementing at least a portion of one or more systems, at least a portion of one or more flowcharts, at least a portion of one or more methods, and/or at least a portion of one or more processes described herein. In one example, processor 120 may execute processor instructions from one or more of memory media 150, 160, and 170 in implementing at least a portion of one or more systems, at least a portion of one or more flowcharts, at least a portion of one or more methods, and/or at least a portion of one or more processes described herein. In another example, processor 120 may execute processor instructions via network interface 180 in implementing at least a portion of one or more systems, at least a portion of one or more flowcharts, at least a portion of one or more methods, and/or at least a portion of one or more processes described herein.

In one or more embodiments, processor 120 may include one or more of a system, a device, and an apparatus operable to interpret and/or execute program instructions and/or process data, among others, and may include one or more of a microprocessor, a microcontroller, a digital signal processor (DSP), an application specific integrated circuit (ASIC), and another digital or analog circuitry configured to interpret and/or execute program instructions and/or process data, among others. In one example, processor 120 may interpret and/or execute program instructions and/or process data stored locally (e.g., via memory media 150, 160, and 170 and/or another component of IHS 110). In another example, processor 120 may interpret and/or execute program instructions and/or process data stored remotely (e.g., via a network storage resource).

In one or more embodiments, I/O subsystem 175 may represent a variety of communication interfaces, graphics interfaces, video interfaces, user input interfaces, and/or peripheral interfaces, among others. For example, I/O subsystem 175 may include one or more of a touch panel and a display adapter, among others. For instance, a touch panel may include circuitry that enables touch functionality in conjunction with a display that is driven by a display adapter.

As shown, non-volatile memory medium 160 may include an operating system (OS) 162, and applications (APPs) 164-168. In one or more embodiments, one or more of OS 162 and APPs 164-168 may include processor instructions executable by processor 120. In one example, processor 120 may execute processor instructions of one or more of OS 162 and APPs 164-168 via non-volatile memory medium 160. In another example, one or more portions of the processor instructions of the one or more of OS 162 and APPs 164-168 may be transferred to volatile memory medium 150, and processor 120 may execute the one or more portions of the processor instructions of the one or more of OS 162 and APPs 164-168 via volatile memory medium 150.

As illustrated, non-volatile memory medium 170 may include information handling system firmware (IHSFW) 172. In one or more embodiments, IHSFW 172 may include processor instructions executable by processor 120. For example, IHSFW 172 may include one or more structures and/or one or more functionalities of and/or compliant with one or more of a basic input/output system (BIOS), an Extensible Firmware Interface (EFI), a Unified Extensible Firmware Interface (UEFI), and an Advanced Configuration and Power Interface (ACPI), among others. In one instance, processor 120 may execute processor instructions of IHSFW 172 via non-volatile memory medium 170. In another instance, one or more portions of the processor instructions of IHSFW 172 may be transferred to volatile memory medium 150, and processor 120 may execute the one or more portions of the processor instructions of IHSFW 172 via volatile memory medium 150.

In one or more embodiments, OS 162 may include a management information exchange. In one example, the management information exchange may permit multiple components to exchange management information associated with managed elements and/or may permit control and/or management of the managed elements. In another example, the management information exchange may include a driver and/or a driver model that may provide an OS interface through which managed elements (e.g., elements of IHS 110) may provide information and/or notifications, among others. In one instance, the management information exchange may be or include a Windows Management Interface (WMI) for ACPI (available from Microsoft Corporation). In another instance, the management information exchange may be or include a Common Information Model (CIM) (available via the Distributed Management Task Force). In one or more embodiments, the management information exchange may include a combination of the WMI and the CIM. For example, WMI may be and/or may be utilized as an interface to the CIM. For instance, the WMI may be utilized to provide and/or send CIM object information to OS 162.

In one or more embodiments, processor 120 and one or more components of IHS 110 may be included in a system-on-chip (SoC). For example, the SoC may include processor 120 and a platform controller hub (not specifically illustrated).

In one or more embodiments, BMC 130 may be or include a remote access controller. For example, the remote access controller may be or include a DELL™ Remote Access Controller (DRAC). In one or more embodiments, a remote access controller may be integrated into IHS 110. For example, the remote access controller may be or include an integrated DELL™ Remote Access Controller (iDRAC). In one or more embodiments, a remote access controller may include one or more of a processor, a memory, and a network interface, among others. In one or more embodiments, a remote access controller may access one or more busses and/or one or more portions of IHS 110. For example, the remote access controller may include and/or may provide power management, virtual media access, and/or remote console capabilities, among others, which may be available via a web browser and/or a command line interface. For instance, the remote access controller may provide and/or permit an administrator (e.g., a user) one or more abilities to configure and/or maintain an information handling system as if the administrator was at a console of the information handling system and/or had physical access to the information handling system.

In one or more embodiments, a remote access controller may interface with baseboard management controller integrated circuits. In one example, the remote access controller may be based at least on an Intelligent Platform Management Interface (IPMI) standard. For instance, the remote access controller may allow and/or permit utilization of IPMI out-of-band interfaces such as IPMI Over LAN (local area network). In another example, the remote access controller may be based at least on a Redfish standard. In one instance, one or more portions of the remote access controller may be compliant with one or more portions of a Redfish standard. In another instance, one or more portions of the remote access controller may implement one or more portions of a Redfish standard. In one or more embodiments, a remote access controller may include and/or provide one or more internal private networks. For example, the remote access controller may include and/or provide one or more of an Ethernet interface, a front panel USB interface, and a Wi-Fi interface, among others. In one or more embodiments, a remote access controller may be, include, or form at least a portion of a virtual KVM (keyboard, video, and mouse) device. For example, a remote access controller may be, include, or form at least a portion of a KVM over IP (IPKVM) device. For instance, a remote access controller may capture video, keyboard, and/or mouse signals; may convert the signals into packets; and may provide the packets to a remote console application via a network.

In one or more embodiments, BMC 130 may be or include a microcontroller. For example, the microcontroller may be or include an 8051 microcontroller, an ARM Cortex-M (e.g., Cortex-M0, Cortex-M1, Cortex-M3, Cortex-M4, Cortex-M7, etc.) microcontroller, a MSP430 microcontroller, an AVR (e.g., 8-bit AVR, AVR-32, etc.) microcontroller, a PIC microcontroller, a 68HC11 microcontroller, a ColdFire microcontroller, and a Renesas microcontroller, among others. In one or more embodiments, BMC 130 may be or include an application processor. In one example, BMC 130 may be or include an ARM Cortex-A processor. In another example, BMC 130 may be or include an Intel Atom processor. In one or more embodiments, BMC 130 may be or include one or more of a field programmable gate array (FPGA) and an ASIC, among others, configured, coded, and/or encoded with instructions in accordance with at least a portion of one or more of systems, at least a portion of one or more flowcharts, at least a portion of one or more methods, and/or at least a portion of one or more processes described herein.

In one or more embodiments, an information handling system may include a RAID controller. For example, IHS 110A may include hardware RAID controllers 140A-140N, as illustrated in FIG. 1A. For instance, RAID controllers 140A-140N may be communicatively coupled to processor 120 of IHS 110A. As an example, RAID controllers 140A-140N may be communicatively coupled to a root complex (not specifically illustrated) of IHS 110A. In one or more embodiments, a RAID controller may be associated with an endpoint ID. For example, hardware RAID controllers 140A-140N may be respectively associated with different IDs.

In one or more embodiments, an information handling system may include drives of a RAID. In one example, IHS 110A may include drives 142AA-142AN of a first RAID, as illustrated in FIG. 1A. For instance, a first RAID system may include RAID controller 140A and drives 142AA-142AN. In one or more embodiments, drives 142AA-142AN may be communicatively coupled to RAID controller 140A. Although drives 142AA-142AN are illustrated, the first RAID system may include any number of drives 142, according to one or more embodiments. In another example, IHS 110A may include drive 142NA-142NN of a second RAID, as shown in FIG. 1A. For instance, a second RAID system may include RAID controller 140N and drives 142NA-142NN. In one or more embodiments, drives 142NA-142NN may be communicatively coupled to RAID controller 140N. Although drives 142NA-142NN are illustrated, the second RAID system may include any number of drives 142, according to one or more embodiments.

In one or more embodiments, RAID controllers 140A-140N may be communicatively coupled to processor 120 of IHS 110B, as shown in FIG. 1B. For example, RAID controllers 140A-140N may be communicatively coupled to a root complex (not specifically illustrated) of IHS 110B. In one or more embodiments, an information handling system may include a first portion drives of a RAID, and a second portion of the RAID may be external to the RAID. In one example, IHS 110B may include drives 142AA-142AM of a first RAID, and drive 142AN of the first RAID may be external to IHS 110B, as illustrated in FIG. 1B. For instance, a first RAID system may include RAID controller 140A and drives 142AA-142AN. In one or more embodiments, drives 142AA-142AN may be communicatively coupled to RAID controller 140A. Although drives 142AA-142AN are illustrated, the first RAID system may include any number of drives 142, according to one or more embodiments. In another example, IHS 110B may include drives 142NA and 142NB of a second RAID, and drives 142NC-142NN of the second RAID may be external to IHS 110B, as shown in FIG. 1B. For instance, a second RAID system may include RAID controller 140N and drives 142NA-142NN. In one or more embodiments, drives 142NA-142NN may be communicatively coupled to RAID controller 140N. Although drives 142NA-142NN are illustrated, the second RAID system may include any number of drives 142, according to one or more embodiments.

In one or more embodiments, an information handling system may be communicatively coupled to a RAID system, as illustrated in FIG. 1C. For example, an IHS 110D may be or include a second RAID system. For instance, IHS 110D may include RAID controller 140N and drives 142NA-142NN, as illustrated in FIG. 1C. In one or more embodiments, drives 142NA-142NN may be communicatively coupled to RAID controller 140N. Although drives 142NA-142NN are illustrated, IHS 110D may include any number of drives 142, according to one or more embodiments. In one or more embodiments, an IHS 110C may be communicatively coupled to IHS 110D. For example, RAID controller 140N may be communicatively coupled to processor 120 of IHS 110C. For instance, RAID controller 140N may be communicatively coupled to a root complex (not specifically illustrated) of IHS 110C.

In one or more embodiments, an information handling system may include one or more hardware RAID controllers. For example, IHS 110C may include hardware RAID controllers 140A-140M, as illustrated in FIG. 1C. For instance, RAID controllers 140A-140M may be communicatively coupled to processor 120 of IHS 110C. As an example, RAID controllers 140A-140M may be communicatively coupled to a root complex (not specifically illustrated) of IHS 110C. In one or more embodiments, a third RAID system may include RAID controller 140M and drives 142MA-142MN. For example, drives 142MA-142MN may be communicatively coupled to RAID controller 140M. Although drives 142MA-142MN are illustrated, the third RAID system may include any number of drives 142, according to one or more embodiments.

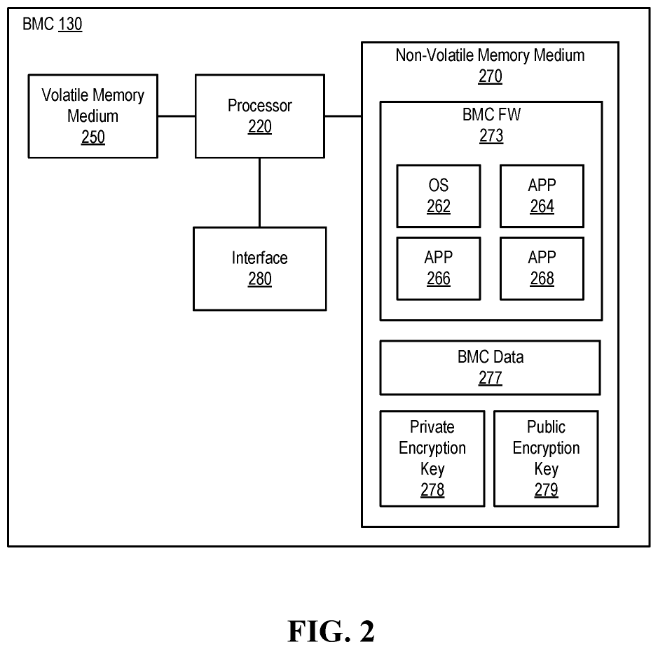

Turning now to FIG. 2, an example of a baseboard management controller is illustrated, according to one or more embodiments. As shown, BMC 130 may include a processor 220, a volatile memory medium 250, a non-volatile memory medium 270, and an interface 280. As illustrated, non-volatile memory medium 270 may include a BMC firmware (FW) 273, which may include an OS 262 and APPs 264-268, and may include BMC data 277. In one example, OS 262 may be or include a real-time operating system (RTOS). For instance, the RTOS may be or include FreeRTOS, OpenRTOS, SafeRTOS, QNX, ThreadX, VxWorks, NuttX, TI-RTOS, eCos, MicroC/OS, or Zephyr, among others. In a second example, OS 262 may be or include an Unix-like operating system. For instance, the Unix-like operating system may be or include LINUX®, FREEBSD®, NETBSD®, OpenBSD, Minix, Xinu, or Darwin, among others. In another example, OS 262 may be or include a portable operating system interface (POSIX) compliant operating system. As illustrated, non-volatile memory medium 270 may include a private encryption key 278. As shown, non-volatile memory medium 270 may include a public encryption key 279. In one or more embodiments, private encryption key 278 may be different from public encryption key 279. For example, private encryption key 278 and public encryption key 279 may be asymmetric encryption keys. In one instance, data encrypted via private encryption key 278 may be decrypted via public encryption key 279. In another instance, data encrypted via public encryption key 279 may be decrypted via private encryption key 278.

In one or more embodiments, interface 280 may include circuitry that enables communicatively coupling to one or more devices. In one example, interface 280 may include circuitry that enables communicatively coupling to one or more buses. For instance, the one or more buses may include one or more buses described herein, among others. In a second example, interface 280 may include circuitry that enables one or more interrupt signals to be received. In one instance, interface 280 may include general purpose input/output (GPIO) circuitry, and the GPIO circuitry may enable one or more interrupt signals to be received and/or provided via at least one interrupt line. In another instance, interface 280 may include GPIO circuitry that may enable BMC 130 to provide and/or receive signals associated with other circuitry (e.g., diagnostic circuitry, etc.). In a third example, interface 280 may include circuitry that enables communicatively coupling to one or more networks. In one instance, interface 280 may include circuitry that enables communicatively coupling to network interface 180. In another example, interface 280 may include a network interface.

In one or more embodiments, one or more of OS 262 and APPs 264-268 may include processor instructions executable by processor 220. In one example, processor 220 may execute processor instructions of one or more of OS 262 and APPs 264-268 via non-volatile memory medium 270. In another example, one or more portions of the processor instructions of the one or more of OS 262 and APPs 264-268 may be transferred to volatile memory medium 250, and processor 220 may execute the one or more portions of the processor instructions of the one or more of OS 262 and APPs 264-268 via volatile memory medium 250. In one or more embodiments, processor 220 may execute instructions in accordance with at least a portion of one or more systems, at least a portion of one or more flowcharts, one or more methods, and/or at least a portion of one or more processes described herein. For example, non-volatile memory medium 270 and/or volatile memory medium 250 may store instructions that may be executable in accordance with at least a portion of one or more systems, at least a portion of one or more flowcharts, at least a portion of one or more methods, and/or at least a portion of one or more processes described herein. In one or more embodiments, processor 220 may execute instructions in accordance with at least a portion of one or more of systems, flowcharts, at least a portion of one or more methods, and/or at least a portion of one or more processes described herein. For example, non-volatile memory medium 270 and/or volatile memory medium 250 may store instructions that may be executable in accordance with at least a portion of one or more of systems, at least a portion of one or more flowcharts, at least a portion of one or more methods, and/or at least a portion of one or more processes described herein. In one or more embodiments, processor 220 may utilize BMC data 277. In one example, processor 220 may utilize BMC data 277 via non-volatile memory medium 270. In another example, one or more portions of BMC data 277 may be transferred to volatile memory medium 250, and processor 220 may utilize BMC data 277 via volatile memory medium 250.

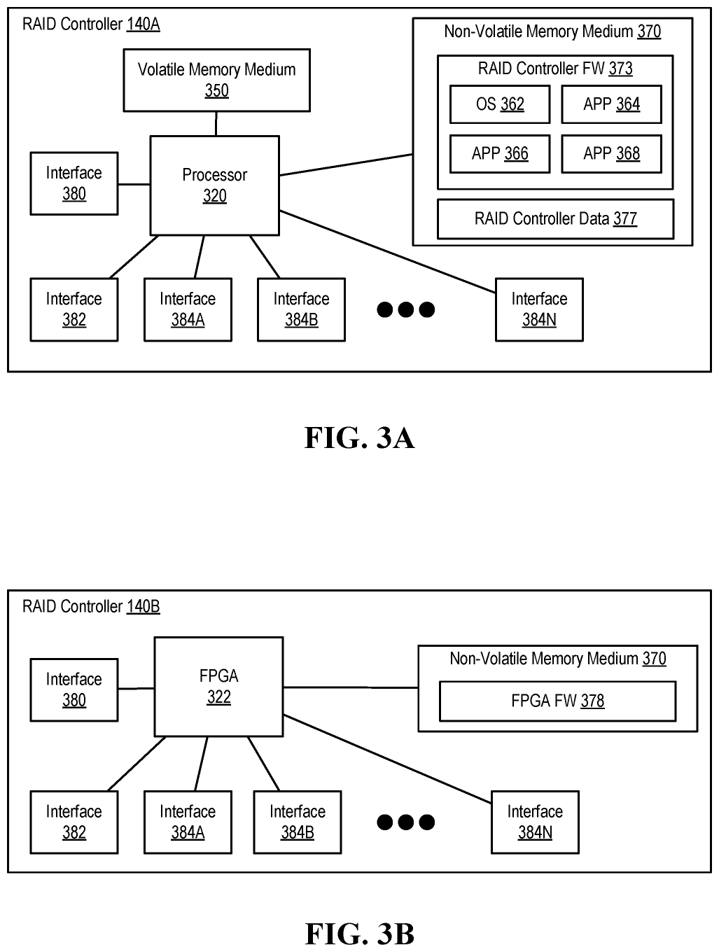

Turning now to FIG. 3A, an example of a RAID controller is illustrated, according to one or more embodiments. As shown, a RAID controller 140A may include a processor 320, a volatile memory medium 350, a non-volatile memory medium 370, and an interface 380. As illustrated, non-volatile memory medium 370 may include a RAID controller FW 373, which may include an OS 362 and APPs 364-368, and may include RAID controller data 377. In one example, OS 362 may be or include a RTOS. For instance, the RTOS may be or include FreeRTOS, OpenRTOS, SafeRTOS, QNX, ThreadX, VxWorks, NuttX, TI-RTOS, eCos, MicroC/OS, or Zephyr, among others. In a second example, OS 362 may be or include an Unix-like operating system. For instance, the Unix-like operating system may be or include LINUX®, FREEBSD®, NETBSD®, OpenBSD, Minix, Xinu, or Darwin, among others. In another example, OS 362 may be or include a POSIX compliant operating system.

In one or more embodiments, interface 380 may include circuitry that enables communicatively coupling to one or more devices. In one example, interface 380 may include circuitry that enables communicatively coupling to one or more buses. For instance, the one or more buses may include one or more buses described herein, among others. In a second example, interface 380 may include circuitry that enables one or more interrupt signals to be received. In one instance, interface 380 may include GPIO circuitry, and the GPIO circuitry may enable one or more interrupt signals to be received and/or provided via at least one interrupt line. In another instance, interface 380 may include GPIO circuitry that may enable RAID controller 140A to provide and/or receive signals associated with other circuitry. In a third example, interface 380 may include circuitry that enables communicatively coupling to one or more networks.

In one or more embodiments, one or more of OS 362 and APPs 364-368 may include processor instructions executable by processor 320. In one example, processor 320 may execute processor instructions of one or more of OS 362 and APPs 364-368 via non-volatile memory medium 370. In another example, one or more portions of the processor instructions of the one or more of OS 362 and APPs 364-368 may be transferred to volatile memory medium 350, and processor 320 may execute the one or more portions of the processor instructions of the one or more of OS 362 and APPs 364-368 via volatile memory medium 350. In one or more embodiments, processor 320 may execute instructions in accordance with at least a portion of one or more systems, at least a portion of one or more flowcharts, one or more methods, and/or at least a portion of one or more processes described herein. For example, non-volatile memory medium 370 and/or volatile memory medium 350 may store instructions that may be executable in accordance with at least a portion of one or more systems, at least a portion of one or more flowcharts, at least a portion of one or more methods, and/or at least a portion of one or more processes described herein. In one or more embodiments, processor 320 may execute instructions in accordance with at least a portion of one or more of systems, flowcharts, at least a portion of one or more methods, and/or at least a portion of one or more processes described herein. For example, non-volatile memory medium 370 and/or volatile memory medium 350 may store instructions that may be executable in accordance with at least a portion of one or more of systems, at least a portion of one or more flowcharts, at least a portion of one or more methods, and/or at least a portion of one or more processes described herein. In one or more embodiments, processor 320 may utilize RAID controller data 377. In one example, processor 320 may utilize RAID controller data 377 via non-volatile memory medium 370. In another example, one or more portions of RAID controller data 377 may be transferred to volatile memory medium 350, and processor 320 may utilize RAID controller data 377 via volatile memory medium 350.

In one or more embodiments, a RAID controller 140 may include an interface 382. For example, interface 382 may be compliant with a PCIe specification. For instance, interface 382 may be communicatively coupled to a PCIe interface of IHS 110. In one or more embodiments, a RAID controller 140 may include interfaces 384A-384N. For example, an interface 384 may be configured to be communicatively coupled to a drive 142. For instance, an interface 384 may be compliant with one or more of a SATA specification, a SAS specification, a SCSI specification, a Thunderbolt specification, and a USB specification, among others. Although interfaces 384A-384N, a RAID controller 140 may include any number of interfaces 384, according to one or more embodiments. In one or more embodiments, a RAID controller 140 may include one or more structures and/or one or more functionalities of those described with reference to RAID controller 140A.

Turning now to FIG. 3B, another example of a RAID controller is illustrated, according to one or more embodiments. As shown, a RAID controller 140B may include a FPGA 322, a non-volatile memory medium 370, and an interface 380. As illustrated, non-volatile memory medium 370 may include a RAID controller FW 378. Although not specifically illustrated, FPGA 322 may include one or more of non-volatile memory medium 370 and RAID controller FW 378, according to one or more embodiments.

In one or more embodiments, interface 380 may include circuitry that enables communicatively coupling to one or more devices. In one example, interface 380 may include circuitry that enables communicatively coupling to one or more buses. For instance, the one or more buses may include one or more buses described herein, among others. In a second example, interface 380 may include circuitry that enables one or more interrupt signals to be received. In one instance, interface 380 may include GPIO circuitry, and the GPIO circuitry may enable one or more interrupt signals to be received and/or provided via at least one interrupt line. In another instance, interface 380 may include GPIO circuitry that may enable RAID controller 140B to provide and/or receive signals associated with other circuitry. In a third example, interface 380 may include circuitry that enables communicatively coupling to one or more networks.

In one or more embodiments, FPGA 322 may be configured in accordance with at least a portion of one or more systems, at least a portion of one or more flowcharts, one or more methods, and/or at least a portion of one or more processes described herein. For example, RAID controller FW 378 may be configured in accordance with at least a portion of one or more systems, at least a portion of one or more flowcharts, one or more methods, and/or at least a portion of one or more processes described herein. For instance, RAID controller FW 378 may configure FPGA 322 in accordance with at least a portion of one or more systems, at least a portion of one or more flowcharts, one or more methods, and/or at least a portion of one or more processes described herein.

In one or more embodiments, a RAID controller 140 may include an interface 382. For example, interface 382 may be compliant with a PCIe specification. For instance, interface 382 may be communicatively coupled to a PCIe interface of IHS 110. In one or more embodiments, a RAID controller 140 may include interfaces 384A-384N. For example, an interface 384 may be configured to be communicatively coupled to a drive 142. For instance, an interface 384 may be compliant with one or more of a SATA specification, a SAS specification, a SCSI specification, a Thunderbolt specification, and a USB specification, among others. Although interfaces 384A-384N, a RAID controller 140 may include any number of interfaces 384. In one or more embodiments, a RAID controller 140 may include one or more structures and/or one or more functionalities of those described with reference to RAID controller 140B.

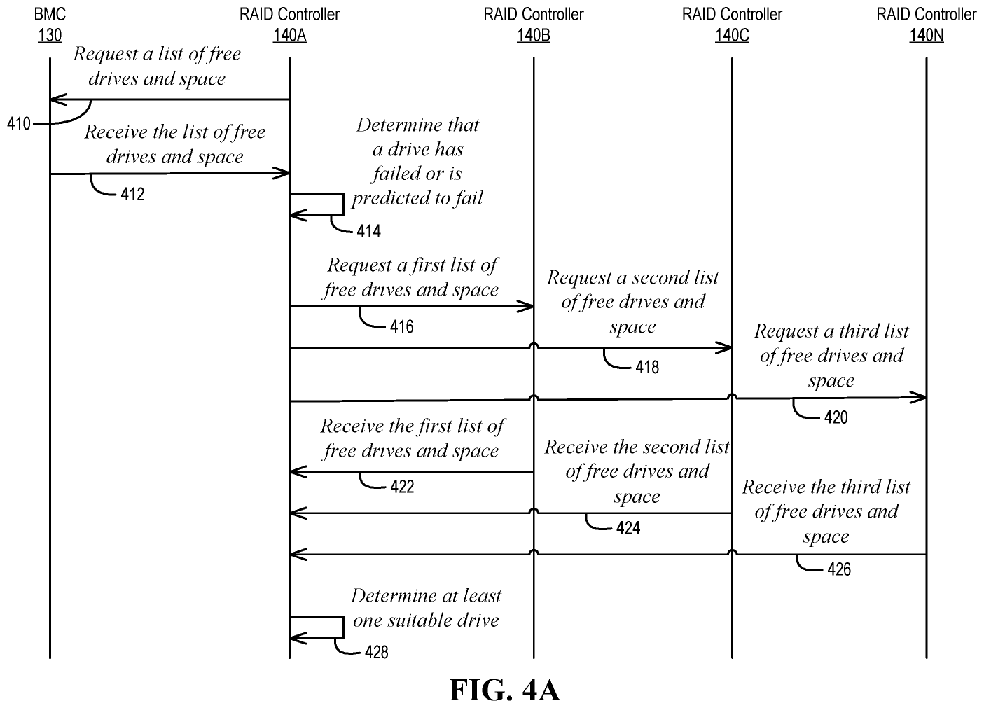

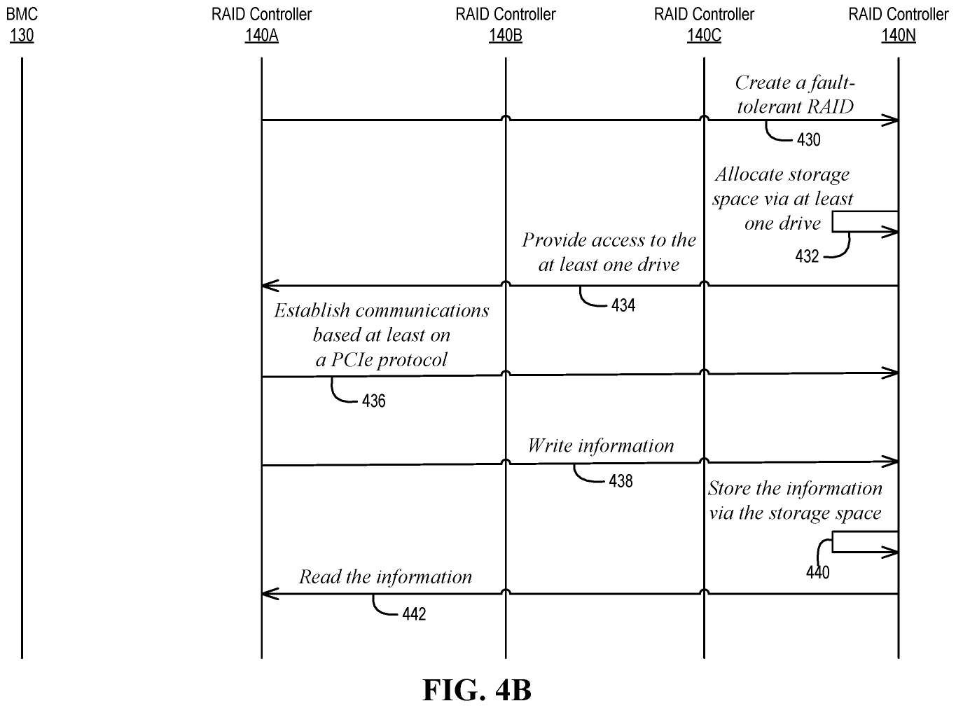

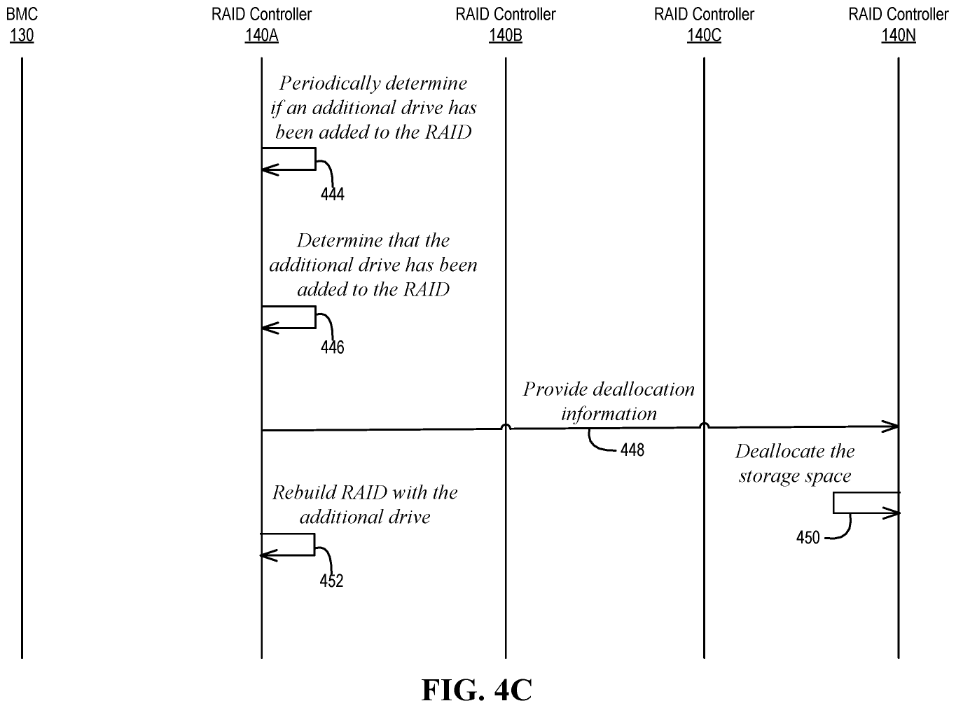

Turning now to FIGS. 4A-4C, an example of a sequence diagram of operating an information handling system is illustrated, according to one or more embodiments. At 410, RAID controller 140A may request a list of free drives and free storage space from BMC 130. For example, BMC 130 may receive a request the list of free drives and free storage space. For instance, the list of free drives and free storage space may include identifications of RAID controllers 140B, 140C, and 140N. In one or more embodiments, free storage space may be available unallocated storage space of a drive. At 412, RAID controller 140A may receive the list of free drives and space from BMC 130. For example, BMC 130 may provide the list of free drives and free storage space from BMC 130 to RAID controller 140A.

At 414, RAID controller 140A may determine that a drive has failed or is predicted to fail. At 416, RAID controller 140A may request a first list of free drives and space from RAID controller 140B. For example, RAID controller 140B may receive a request for the first list of free drives and free storage space from RAID controller 140A. At 418, RAID controller 140A may request a second list of free drives and free storage space from RAID controller 140C. For example, RAID controller 140C may receive a request for the second list of free drives and free storage space from RAID controller 140A. At 420, RAID controller 140A may request a third list of free drives and free storage space from RAID controller 140N. For example, RAID controller 140N may receive a request for the third list of free drives and free storage space from RAID controller 140A.

At 422, RAID controller 140A may receive the first list of free drives and free storage space from RAID controller 140B. For example, RAID controller 140B may provide the first list of free drives and free storage space to RAID controller 140A. At 424, RAID controller 140A may receive the second list of free drives and free storage space from RAID controller 140C. For example, RAID controller 140C may provide the second list of free drives and free storage space to RAID controller 140A. At 426, RAID controller 140A may receive the third list of free drives and free storage space from RAID controller 140N. For example, RAID controller 140N may provide the first list of free drives and free storage space to RAID controller 140A.

At 428, RAID controller 140A may determine at least one suitable drive. For example, RAID controller 140A may determine at least one suitable drive from the first list of free drives and free storage space, the second list of free drives and free storage space, and the third list of free drives and free storage space. In one or more embodiments, RAID controller 140A may determine the at least one suitable drive based at least on one or more characteristics of the drive that has failed or is predicted to fail. In one example, the drive that has failed or is predicted to fail may include spinning magnetic storage media, and RAID controller 140A may determine the at least one suitable drive that also includes spinning magnetic storage media rather than a SSD. In another example, the drive that has failed or is predicted to fail may include a SSD, and RAID controller 140A may determine the at least one suitable drive that also includes a SSD rather than a drive that includes spinning magnetic storage media. In one or more embodiments, RAID controller 140A may determine the at least one suitable drive based at least on a processor socket domain. For example, RAID controller 140A may determine the at least one suitable drive from a RAID controller on a same processor socket domain rather than a RAID controller on a different processor socket domain.

At 430, RAID controller 140A may create a fault-tolerant RAID utilizing space and at least one drive associated with RAID controller 140N. For example, RAID controller 140A may provide a request for an allocation of storage space to RAID controller 140N. In one instance, RAID controller 140A may request a virtual drive from RAID controller 140N. In another instance, RAID controller 140A may request access of the at least one drive from RAID controller 140N. At 432, RAID controller 140N may allocate storage space via at least one drive.

At 434, RAID controller 140N may provide, to RAID controller 140A, access to the at least one drive. For example, RAID controller 140N providing, to RAID controller 140A, access to the at least one drive may include RAID controller 140N providing, to RAID controller 140A, a virtual drive to RAID controller 140A. In one or more embodiments, RAID controller 140N providing, to RAID controller 140A, access to the at least one drive may include RAID controller 140N providing, to RAID controller 140A, an endpoint ID associated with RAID controller 140N. For example, RAID controller 140N may access the at least one drive via the endpoint ID associated with RAID controller 140N. For instance, RAID controller 140N may access the virtual drive via the endpoint ID associated with RAID controller 140N.

At 436, RAID controller 140A may establish communications with RAID controller 140N based at least on a PCIe protocol. For example, RAID controller 140A establishing communications with RAID controller 140N based at least on the PCIe protocol may include RAID controller 140A establishing I/O with RAID controller 140N based at least on the PCIe protocol. At 438, RAID controller 140A may write information to RAID controller 140N. For example, RAID controller 140A may write information to the virtual drive provided by RAID controller 140N. In one or more embodiments, RAID controller 140A writing the information to RAID controller 140N may include RAID controller 140A providing, based at least on the information, first one or more vendor defined messages to RAID controller 140N via the PCIe protocol. For example, the first one or more vendor defined messages may encapsulate the information.

At 440, RAID controller 140N may store the information via the storage space. For example, RAID controller 140N may store the information via the virtual drive provided by RAID controller 140N. At 442, RAID controller 140A may read the information from RAID controller 140N. For example, RAID controller 140A may read the information from the virtual drive provided by RAID controller 140N. In one or more embodiments, RAID controller 140A reading the information from RAID controller 140N may include RAID controller 140A receiving, based at least on the information, second one or more vendor defined messages from RAID controller 140N via the PCIe protocol. For example, the second one or more vendor defined messages may encapsulate the information.

At 444, RAID controller 140A may periodically determine if an additional drive has been added to the RAID. For example, RAID controller 140A may periodically determine if a replacement drive for the drive that has failed or is predicted to fail. At 446, RAID controller 140A may determine that the additional drive has been added to the RAID. For example, RAID controller 140A may determine that the replacement drive for the drive that has failed or is predicted to fail has been added to the RAID. At 448, RAID controller 140A may provide deallocation information to RAID controller 140N. For example, the deallocation information may indicate that the virtual drive is no longer needed, that the virtual drive can be deallocated, or that the virtual drive can be removed.

At 450, RAID controller 140N may deallocate the storage space. For example, RAID controller 140N may deallocate the storage space utilized for the virtual drive. At 452, RAID controller 140A may rebuild the RAID with the additional drive. For example, RAID controller 140A may rebuild the RAID with the replacement drive for the drive that has failed or is predicted to fail has been added to the RAID.

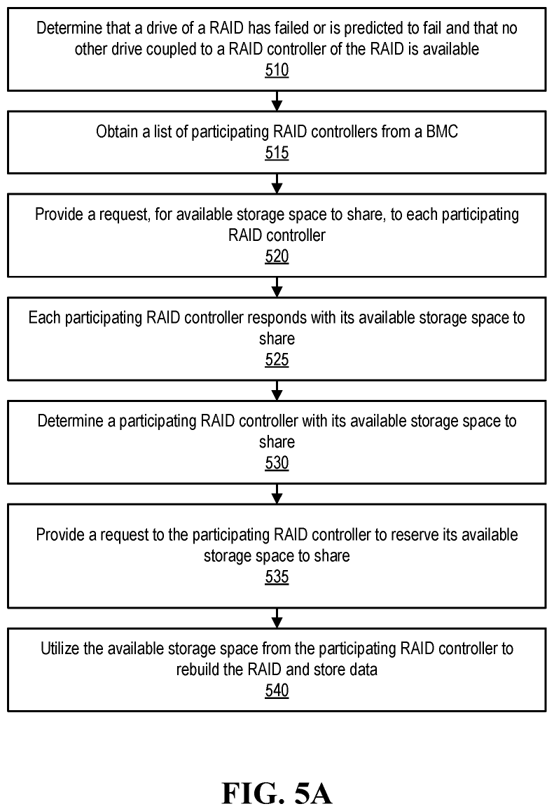

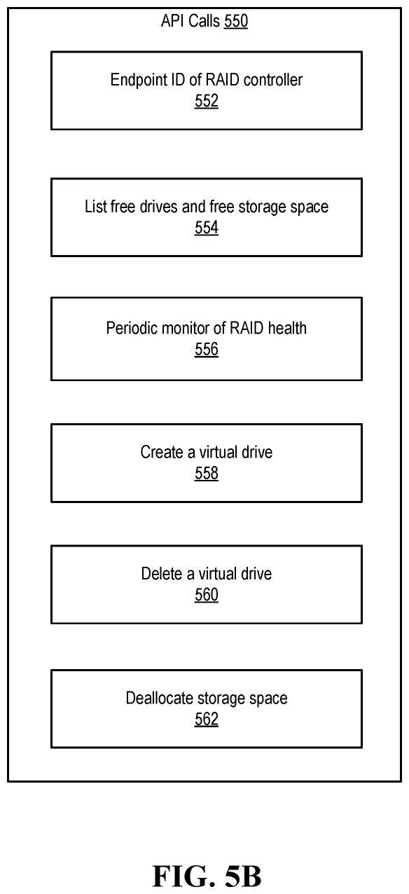

Turning now to FIG. 5A, an example of a method of operating an information handling system is illustrated, according to one or more embodiments. At 510, a RAID controller may determine that a drive of a RAID has failed or is predicted to fail and that no other drive coupled to the RAID controller of the RAID is available. For example, RAID controller 140A may determine that a drive of a RAID has failed or is predicted to fail and that no other drive coupled to the RAID controller of the RAID is available. At 515, the RAID controller may obtain a list of participating RAID controllers from a BMC. For example, RAID controller 140A may obtain a list of participating RAID controllers from BMC 130.

At 520, the RAID controller may provide a request, for available storage space to share, to each participating RAID controller of the list of participating RAID controllers. For example, RAID controller 140A may provide a request, for available storage space to share, to each participating RAID controller of the list of participating RAID controllers. For instance, the list of participating RAID controllers may include identifications of one or more of RAID controllers 140B, 140C, and 140N, among others. In one or more embodiments, providing the request, for available storage space to share, to each participating RAID controller of the list of participating RAID controllers may include providing the request to each endpoint ID of each participating RAID controller of the list of participating RAID controllers. For example, RAID controller 140A may provide a request, for available storage space to share, to each endpoint ID of participating RAID controller of the list of participating RAID controllers. For instance, the list of participating RAID controllers may include identifications of one or more of RAID controllers 140B, 140C, and 140N, among others.

At 525, each participating RAID controller may respond with its available storage space to share. For example, each of one or more of RAID controllers 140B, 140C, and 140N, among others, may respond with its available storage space to share with RAID controller 140A. At 530, the RAID controller may determine a participating RAID controller with its available storage space to share. For example, RAID controller 140A may determine a participating RAID controller with its available storage space to share. For instance, RAID controller 140A may determine a participating RAID controller with its available storage space to share from RAID controllers 140B, 140C, and 140N, among others.

At 535, the RAID controller may provide a request to the participating RAID controller to reserve its available storage space to share. For example, RAID controller 140A may provide a request to the participating RAID controller to reserve its available storage space to share. In one instance, RAID controller 140A may provide a request to RAID controller 140B to reserve its available storage space to share. In a second instance, RAID controller 140A may provide a request to RAID controller 140C to reserve its available storage space to share. In another instance, RAID controller 140A may provide a request to RAID controller 140N to reserve its available storage space to share.

At 540, the RAID controller may utilize the available storage space from the participating RAID controller to rebuild the RAID and store data. In one example, RAID controller 140A may utilize the available storage space from RAID controller 140B to rebuild the RAID and store data. In a second example, RAID controller 140A may utilize the available storage space from RAID controller 140C to rebuild the RAID and store data. In another example, RAID controller 140A may utilize the available storage space from RAID controller 140N to rebuild the RAID and store data.

Turning now to FIG. 5B, an example of API calls is illustrated, according to one or more embodiments. In one or more embodiments, a memory medium may be coded and/or encoded with processor-executable instructions with API calls (e.g., subroutine calls) in accordance with at least a portion of one or more flowcharts, at least a portion of one or more systems, at least a portion of one or more methods, and/or at least a portion of one or more processes described herein to. In one or more embodiments, a programmable logic device (e.g., a FPGA) may be coded, encoded, and/or configured with processor-executable instructions with API calls (e.g., subroutine calls) in accordance with at least a portion of one or more flowcharts, at least a portion of one or more systems, at least a portion of one or more methods, and/or at least a portion of one or more processes described herein.

In one or more embodiments, a memory medium may be include API calls 550. For example, API calls 550 may include instructions executable by a processor to implement at least a portion of one or more systems, at least a portion of one or more flowcharts, at least a portion of one or more methods, and/or at least a portion of one or more processes described herein. In one or more embodiments, a FPGA may be configured with API calls 550. For example, API calls 550 may configure FPGA 322 in accordance with at least a portion of one or more systems, at least a portion of one or more flowcharts, one or more methods, and/or at least a portion of one or more processes described herein. For instance, RAID controller FW 378 may be configured with API calls 550, which may be utilized to configure FPGA 322 in accordance with at least a portion of one or more systems, at least a portion of one or more flowcharts, one or more methods, and/or at least a portion of one or more processes described herein. In one or more embodiments, an ASIC may be configured with API calls 550. For example, a RAID controller 140 may include an ASIC may be configured with API calls 550.

In one or more embodiments, API calls 550 may include API calls 552-562, among others. In one example, API call 552 may return an endpoint ID of a RAID controller. In a second example, API call 554 may provide a list of free drives and free storage space. In a third example, API call 556 may periodically monitor a heath of a RAID. In a fourth example, API call 558 may create a virtual drive. In a fifth example, API call 560 may delete a virtual drive. In another example, API call 562 may deallocate storage space.

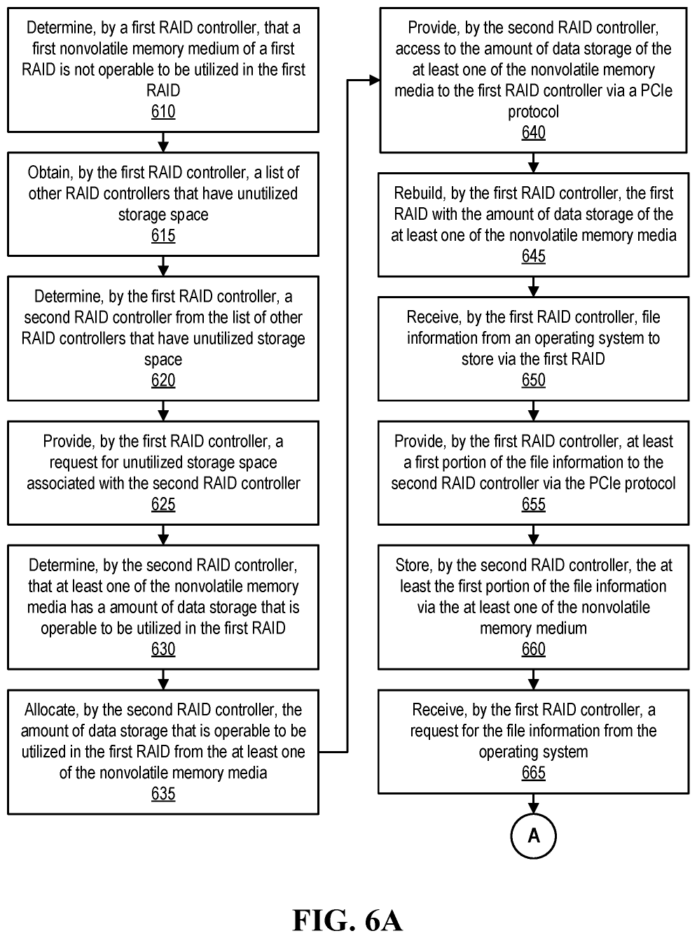

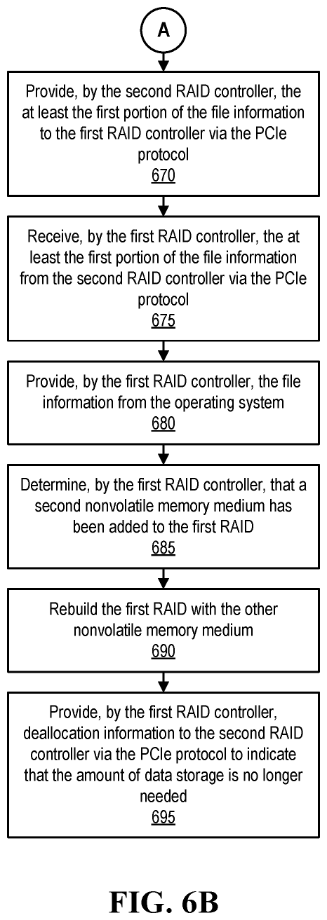

Turning now to FIGS. 6A and 6B, an example of a method of operating RAID controllers is illustrated, according to one or more embodiments. At 610, a first RAID controller may determine that a first nonvolatile memory medium of a first RAID is not operable to be utilized in the first RAID. For example, RAID controller 140A may determine that disk 142AA of a first RAID is not operable to be utilized in the first RAID. For instance, the first RAID may include disks 142AA-142AN. In one or more embodiments, a nonvolatile memory medium that is not operable to be utilized in the first RAID may include a nonvolatile memory medium that has failed. In one or more embodiments, a nonvolatile memory medium that is not operable to be utilized in the first RAID may include a nonvolatile memory medium that is predicted to fail.

At 615, the first RAID controller may obtain a list of other RAID controllers that have unutilized storage space. For example, RAID controller 140A may obtain, from BMC 130, a list of other RAID controllers that have unutilized storage space. For instance, BMC 130 may provide the list of other RAID controllers that have unutilized storage space. As an example, the list of other RAID controllers that have unutilized storage space may include one or more of RAID controllers 140B, 140C, and 140N, among others. In one or more embodiments, RAID controller 140A obtaining the list of other RAID controllers that have unutilized storage space from BMC 130 may include RAID controller 140A receiving the list of other RAID controllers that have unutilized storage space from BMC 130.

At 620, the first RAID controller may determine a second RAID controller from the list of other RAID controllers that have unutilized storage space. For example, RAID controller 140A may determine RAID controller 140N from the list of other RAID controllers that have unutilized storage space. At 625, the first RAID controller may provide a request for unutilized storage space associated with the second RAID controller. For example, RAID controller 140A may provide a request for unutilized storage space associated with RAID controller 140N.

At 630, the second RAID controller may determine that at least one of the nonvolatile memory medium has a amount of data storage that is operable to be utilized in the first RAID. For example, RAID controller 140N may determine that at least one of drives 142NA-142NN has a amount of data storage that is operable to be utilized in the first RAID. In one instance, the at least one of drives 142NA-142NN may include a single drive that has the amount of data storage that is operable to be utilized in the first RAID. In another instance, the at least one of drives 142NA-142NN may include multiple drives that may have portions of the amount of data storage that is operable to be utilized in the first RAID, which may be combined to produce the amount of data storage that is operable to be utilized in the first RAID.

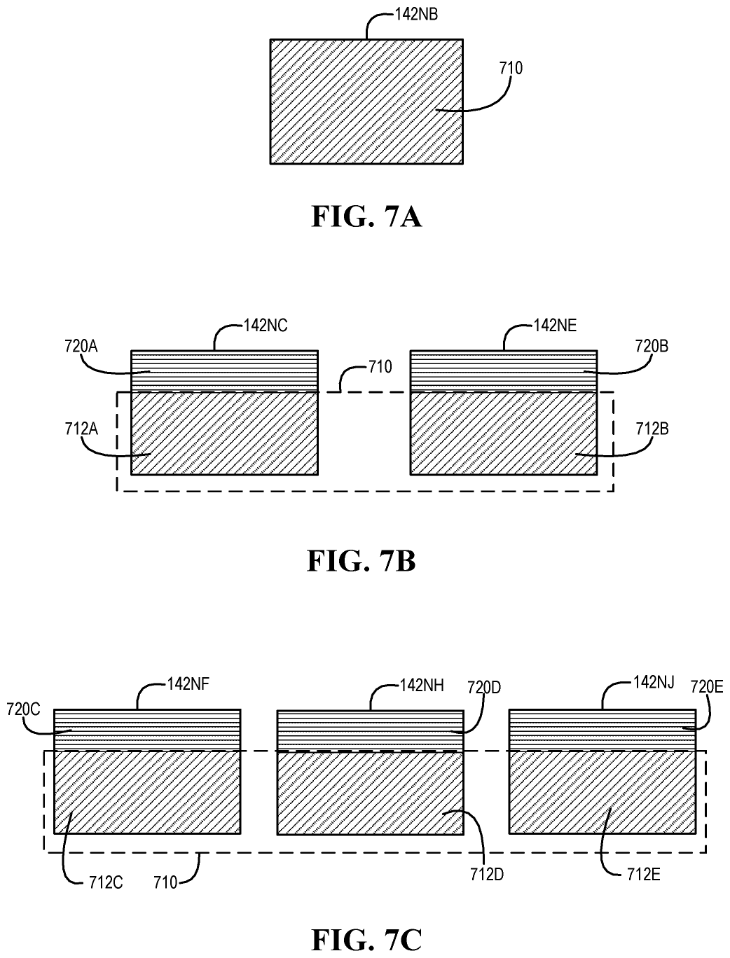

At 635, the second RAID controller may allocate the amount of data storage that is operable to be utilized in the first RAID from the at least one of the nonvolatile memory medium. For example, RAID controller 140N may allocate the amount of data storage that is operable to be utilized in the first RAID from the at least one of drives 142NA-142NN. In one instance, RAID controller 140N may allocate a amount of data storage 710 that is operable to be utilized in the first RAID from drive 142NA, as illustrated in FIG. 7A. In a second instance, RAID controller 140N may allocate a amount of data storage 710 that is operable to be utilized in the first RAID from drives 142NC and 142NE, as shown in FIG. 7B. As an example, a first portion of data storage 712A of drive 142NC and a second portion of data storage 712B of drive 142NE may be combined to produce amount of data storage 710. As another example, a portion of data storage 720A of drive 142NC and a portion of data storage 720B of drive 142NE may not be utilized to produce amount of data storage 710. In another instance, RAID controller 140N may allocate amount of data storage 710 that is operable to be utilized in the first RAID from drives 142NF, 142NH, and 142NJ, as illustrated in FIG. 7C. As an example, a first portion of data storage 712C of drive 142NF, a second portion of data storage 712D of drive 142NH, and a third portion of data storage 712E of drive 142NJ may be combined to produce amount of data storage 710. As another example, a portion of data storage 720C of drive 142NF, a portion of data storage 720D of drive 142NH, and a portion of data storage 720E of drive 142NJ may not be utilized to produce amount of data storage 710.

At 640, the second RAID controller may provide access to the amount of data storage of the at least one of the nonvolatile memory medium to the first RAID controller via a PCIe protocol. For example, RAID controller 140N may provide access to data storage 710 to RAID controller 140A via a PCIe protocol. In one or more embodiments, the PCIe protocol may include a VDM protocol. For example, the PCIe protocol may encapsulate the VDM protocol. For instance, providing the access to the amount of data storage of the at least one of the nonvolatile memory medium to the first RAID controller via the PCIe protocol may include providing the access to the amount of data storage of the at least one of the nonvolatile memory medium to the first RAID controller via the VDM protocol. In one or more embodiments, the PCIe protocol may include a management component transfer protocol (MCTP). For example, the PCIe protocol may encapsulate the MCTP. For instance, providing the access to the amount of data storage of the at least one of the nonvolatile memory medium to the first RAID controller via the PCIe protocol may include providing the access to the amount of data storage of the at least one of the nonvolatile memory medium to the first RAID controller via the MCTP.

In one or more embodiments, a first protocol may encapsulate a second protocol. For example, the PCIe protocol may encapsulate the VDM protocol. In one or more embodiments, the second protocol may encapsulate a third protocol. For example, the VDM protocol may encapsulate the MCTP protocol. For instance, the PCIe protocol may encapsulate the VDM protocol, and the VDM protocol may encapsulate the MCTP protocol. In one or more embodiments, a protocol may encapsulate one or more application programming interfaces (APIs). For example, one or more of the PCIe protocol, the VDM, and the MCTP protocol, among others. For instance, the MCTP protocol may encapsulate one or more APIs. As an example, the MCTP protocol may encapsulate one or more API calls 552-562, among others. For instance, the MCTP protocol may encapsulate API calls 550. As another example, the PCIe protocol may encapsulate the VDM protocol, and the VDM protocol may encapsulate the MCTP protocol, which may encapsulate one or more API calls 552-562, among others. For instance, the PCIe protocol may encapsulate the VDM protocol, and the VDM protocol may encapsulate the MCTP protocol, which may encapsulate API calls 550.

In one or more embodiments, providing the access to the amount of data storage of the at least one of the nonvolatile memory medium to the first RAID controller via the PCIe protocol may include providing a virtual drive to the first RAID controller via the PCIe protocol. For example, RAID controller 140N providing access to data storage 710 to RAID controller 140A via the PCIe protocol may include providing a virtual drive to RAID controller 140A via the PCIe protocol.

At 645, the first RAID controller may rebuild the first RAID with the amount of data storage of the at least one of the nonvolatile memory medium. For example, RAID controller 140A may rebuild the first RAID with the amount of data storage of the at least one of drives 142NA-142NN. At 650, the first RAID controller may receive file information from an operating system to store via the first RAID. For example, RAID controller 140A may receive file information from OS 162 to store via the first RAID. In one instance, the file information may include a file. In a second instance, the file information may include metadata associated with a file. In a third instance, the file information may include a portion of a file. In a fourth instance, the file information may include a directory. In a fifth instance, the file information may include a portion of a directory. In another instance, the file information may include metadata associated with a directory.

In one or more embodiments, the first RAID controller may receive file information from an application to store via the first RAID. For example, RAID controller 140A may receive file information from APP 164 to store via the first RAID. In one instance, the file information may include a file. In a second instance, the file information may include metadata associated with a file. In a third instance, the file information may include a portion of a file. In a fourth instance, the file information may include a directory. In a fifth instance, the file information may include a portion of a directory. In another instance, the file information may include metadata associated with a directory. In one or more embodiments, the first RAID controller may receive, via an operating system, file information from an application to store via the first RAID. For example, RAID controller 140A may receive, via an operating system, file information from APP 164 to store via the first RAID.

At 655, the first RAID controller may provide at least a first portion of the file information to the second RAID controller via the PCIe protocol. For example, RAID controller 140A may provide at least a first portion of the file information to RAID controller 140N via the PCIe protocol. At 660, the second RAID controller may store the at least the first portion of the file information via the at least one of the nonvolatile memory medium. For example, RAID controller 140N may store the at least the first portion of the file information via the at least one of drives 142NA-142NN. In one or more embodiments, the second RAID controller may store the at least the first portion of the file information via the amount of data storage that is operable to be utilized in the first RAID. For example, RAID controller 140N may store the at least the first portion of the file information via data storage 710, which is operable to be utilized in the first RAID.

At 665, the first RAID controller may receive a request for the file information from the operating system. For example, RAID controller 140 may receive a request for the file information from OS 162. In one or more embodiments, the first RAID controller may receive a request for the file information from the application via the operating system. For example, RAID controller 140 may receive a request for the file information from APP 164 via OS 162. At 670, the second RAID controller may provide the at least the first portion of the file information to the first RAID controller via the PCIe protocol. For example, RAID controller 140N may provide the at least the first portion of the file information to RAID controller 140A via the PCIe protocol

At 675, the first RAID controller may receive the at least the first portion of the file information from the second RAID controller via the PCIe protocol. For example, RAID controller 140A may receive the at least the first portion of the file information from RAID controller 140N via the PCIe protocol. At 680, the first RAID controller may provide the file information from the operating system. For example, RAID controller 140A may provide the file information to OS 162. In one or more embodiments, the first RAID controller may provide the file information to an application via the operating system. For example, RAID controller 140A may provide the file information to APP 164 via OS 162.

At 685, the first RAID controller may determine that a second nonvolatile memory medium has been added to the first RAID. For example, RAID controller 140A may determine that another drive has been added to the first RAID. At 690, the first RAID may be rebuilt with the second nonvolatile memory medium. For example, RAID controller 140A may rebuild the first RAID with the second nonvolatile memory medium. At 695, the first RAID controller may provide deallocation information to the second RAID controller via the PCIe protocol to indicate that the amount of data storage is no longer needed. For example, RAID controller 140A may provide deallocation information to RAID controller 140N via the PCIe protocol to indicate that data storage 710 is no longer needed. In one or more embodiments, the second RAID controller may deallocate the amount of data storage. For example, RAID controller 140N may deallocate data storage 710.

In one or more embodiments, one or more of the method and/or process elements and/or one or more portions of a method and/or a process element may be performed in varying orders, may be repeated, or may be omitted. Furthermore, additional, supplementary, and/or duplicated method and/or process elements may be implemented, instantiated, and/or performed as desired, according to one or more embodiments. Moreover, one or more of system elements may be omitted and/or additional system elements may be added as desired, according to one or more embodiments.

In one or more embodiments, a memory medium may be and/or may include an article of manufacture. For example, the article of manufacture may include and/or may be a software product and/or a program product. For instance, the memory medium may be coded and/or encoded with processor-executable instructions in accordance with at least a portion of one or more flowcharts, at least a portion of one or more systems, at least a portion of one or more methods, and/or at least a portion of one or more processes described herein to produce the article of manufacture.

The above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description.

What is claimed is:

1. An information handling system, comprising:
at least one processor;
a memory medium, coupled to the at least one processor, that stores an operating system executable by the at least one processor;
a first redundant array of independent disks (RAID) controller communicatively coupled to the at least one processor; and
a second RAID controller communicatively coupled to the at least one processor;
wherein the first RAID controller is configured to:
determine that a first nonvolatile memory medium of a first RAID is not operable to be utilized in the first RAID;
wherein the second RAID controller is configured to:
determine that at least one of nonvolatile memory medium of a second RAID has a amount of data storage that is operable to be utilized in the first RAID;
allocate the amount of data storage that is operable to be utilized in the first RAID from the at least one of the nonvolatile memory medium of the second RAID; and
provide access to the amount of data storage of the at least one of the nonvolatile memory medium of the second RAID to the first RAID controller via a Peripheral Component Interconnect Express (PCIe) protocol;
wherein the first RAID controller is further configured to:
rebuild the first RAID with the amount of data storage of the at least one of the nonvolatile memory medium of the second RAID;
receive file information from the operating system to store via the first RAID; and
provide at least a first portion of the file information to the second RAID controller via the PCIe protocol;
wherein the second RAID controller is further configured to:
store the at least the first portion of the file information via the at least one of the nonvolatile memory medium of the second RAID; and
wherein the first RAID controller is further configured to:
receive the at least the first portion of the file information from the second RAID controller via the PCIe protocol; and
provide the file information to the operating system.

2. The information handling system of claim 1, wherein the second RAID controller is further configured to provide the at least the first portion of the file information to the first RAID controller via the PCIe protocol.

3. The information handling system of claim 1, wherein the first RAID controller is further configured to receive a request for the file information from the operating system.

4. The information handling system of claim 1, wherein, to provide the access to the amount of data storage of the at least one of nonvolatile memory medium to the first RAID controller via the PCIe protocol, the second RAID controller is further configured to provide a virtual drive to the first RAID controller via the PCIe protocol.

5. The information handling system of claim 1,
wherein the PCIe protocol encapsulates a vendor defined message protocol; and
wherein, to provide the access to the amount of data storage of the at least one of nonvolatile memory medium to the first RAID controller via the PCIe protocol, the second RAID controller is further configured to provide the access to the amount of data storage of the at least one of nonvolatile memory medium to the first RAID controller via the vendor defined message protocol.

6. The information handling system of claim 1, wherein the first RAID controller is further configured to:
determine that a third nonvolatile memory medium has been added to the first RAID;
rebuild the first RAID with the third nonvolatile memory medium; and
provide deallocation information to the second RAID controller via the PCIe protocol to indicate that the amount of data storage is no longer needed.

7. The information handling system of claim 1,
wherein the at least one of nonvolatile memory medium of the second RAID includes a plurality of nonvolatile memory media;
wherein the second RAID controller is further configured to:
determine that a first nonvolatile memory medium of the plurality of nonvolatile memory media includes a first portion of the amount of data storage that is operable to be utilized in the first RAID;
determine that a second nonvolatile memory medium of the plurality of nonvolatile memory media includes a second portion of the amount of data storage that is operable to be utilized in the first RAID;
allocate the first portion of the amount of data storage that is operable to be utilized in the first RAID from the first nonvolatile memory medium of the plurality of nonvolatile memory media;
allocate the second portion of the amount of data storage that is operable to be utilized in the first RAID from the second nonvolatile memory medium of the plurality of nonvolatile memory media; and
provide, via the PCIe protocol, access to the amount of data storage that is operable to be utilized in the first RAID via a combination of portions of the amount of data storage that is operable to be utilized in the first RAID that includes the first portion of the amount of data storage that is operable to be utilized in the first RAID and the second portion of the amount of data storage that is operable to be utilized in the first RAID;
wherein, to rebuild the first RAID with the amount of data storage of the at least one of nonvolatile memory media of the second RAID, the first RAID controller is further configured to rebuild the first RAID with the combination of portions of the amount of data storage that is operable to be utilized in the first RAID.

8. The information handling system of claim 7,
wherein, to store the at least the first portion of the file information via the at least one of the nonvolatile memory medium of the second RAID, the second RAID controller is further configured to store the at least the first portion of the file information via the first portion of the amount of data storage that is operable to be utilized in the first RAID;
wherein, to receive the at least the first portion of the file information from the second RAID controller via the PCIe protocol, the first RAID controller is further configured to receive the at least the first portion of the file information from the second RAID controller from the first portion of the amount of data storage;
wherein the first RAID controller is further configured to provide at least a second portion of the file information to the second RAID controller via the PCIe protocol;
wherein the second RAID controller is further configured to store the at least the second portion of the file information via the second portion of the amount of data storage that is operable to be utilized in the first RAID; and
wherein the first RAID controller is further configured to receive, via the PCIe protocol, the at least the second portion of the file information from the second RAID controller from the second portion of the amount of data storage.

9. A method, comprising:
determining, by a first redundant array of independent disks (RAID) controller, that a first nonvolatile memory medium of a first RAID is not operable to be utilized in the first RAID;
determining, by a second RAID controller, that at least one of nonvolatile memory medium of a second RAID has an amount of data storage that is operable to be utilized in the first RAID;
allocating, by the second RAID controller, the amount of data storage that is operable to be utilized in the first RAID from the at least one of the nonvolatile memory medium of the second RAID;
providing, by the second RAID controller, access to the amount of data storage of the at least one of the nonvolatile memory medium of the second RAID to the first RAID controller via a Peripheral Component Interconnect Express (PCIe) protocol;
rebuilding, by the first RAID controller, the first RAID with the amount of data storage of the at least one of the nonvolatile memory medium of the second RAID;
receiving, by the first RAID controller, file information from an operating system to store via the first RAID;
providing, by the first RAID controller, at least a first portion of the file information to the second RAID controller via the PCIe protocol;
storing, by the second RAID controller, the at least the first portion of the file information via the at least one of the nonvolatile memory medium of the second RAID;
receiving, by the first RAID controller, the at least the first portion of the file information from the second RAID controller via the PCIe protocol; and
providing, by the first RAID controller, the file information to the operating system.

10. The method of claim 9, further comprising:
providing, by the second RAID controller, the at least the first portion of the file information to the first RAID controller via the PCIe protocol.

11. The method of claim 9, further comprising:
receiving, by the first RAID controller, a request for the file information from the operating system.

12. The method of claim 9, wherein the providing the access to the amount of data storage of the at least one of nonvolatile memory medium of the second RAID to the first RAID controller via the PCIe protocol includes providing a virtual drive to the first RAID controller via the PCIe protocol.

13. The method of claim 9,
wherein the PCIe protocol encapsulates a vendor defined message protocol; and
wherein the providing the access to the amount of data storage of the at least one of nonvolatile memory medium to the first RAID controller via the PCIe protocol includes providing the access to the amount of data storage of the at least one of nonvolatile memory medium to the first RAID controller via the vendor defined message protocol.

14. The method of claim 9, further comprising:
determining, by the first RAID controller, that a third nonvolatile memory medium has been added to the first RAID;
rebuilding the first RAID with the third nonvolatile memory medium; and
providing, by the first RAID controller, deallocation information to the second RAID controller via the PCIe protocol to indicate that the amount of data storage is no longer needed.

15. The method of claim 9,
wherein the at least one of nonvolatile memory medium of the second RAID includes a plurality of nonvolatile memory media;
the method further comprising:
determining, by the second RAID controller, that a first nonvolatile memory medium of the plurality of nonvolatile memory media includes a first portion of the amount of data storage that is operable to be utilized in the first RAID;
determining, by the second RAID controller, that a second nonvolatile memory medium of the plurality of nonvolatile memory media includes a second portion of the amount of data storage that is operable to be utilized in the first RAID;
allocating, by the second RAID controller, the first portion of the amount of data storage that is operable to be utilized in the first RAID from the first nonvolatile memory medium of the plurality of nonvolatile memory media;
allocating, by the second RAID controller, the second portion of the amount of data storage that is operable to be utilized in the first RAID from the second nonvolatile memory medium of the plurality of nonvolatile memory media; and
providing, by the second RAID controller via the PCIe protocol, access to the amount of data storage that is operable to be utilized in the first RAID via a combination of portions of the amount of data storage that is operable to be utilized in the first RAID that includes the first portion of the amount of data storage that is operable to be utilized in the first RAID and the second portion of the amount of data storage that is operable to be utilized in the first RAID;
wherein the rebuilding the first RAID with the amount of data storage of the at least one of nonvolatile memory media of the second RAID includes rebuilding the first RAID with the combination of portions of the amount of data storage that is operable to be utilized in the first RAID.

16. The method of claim 15,
wherein the storing, by the second RAID controller, the at least the first portion of the file information via the at least one of the nonvolatile memory medium of the second RAID includes the storing the at least the first portion of the file information via the first portion of the amount of data storage that is operable to be utilized in the first RAID; and
wherein the receiving, by the first RAID controller, the at least the first portion of the file information from the second RAID controller via the PCIe protocol includes receiving the at least the first portion of the file information from the second RAID controller from the first portion of the amount of data storage;
the method further comprising:
providing, by the first RAID controller, at least a second portion of the file information to the second RAID controller via the PCIe protocol;
storing, by the second RAID controller, the at least the second portion of the file information via the second portion of the amount of data storage that is operable to be utilized in the first RAID; and
receiving, by the first RAID controller via the PCIe protocol, the at least the second portion of the file information from the second RAID controller from the second portion of the amount of data storage.

17. A redundant array of independent disks (RAID) controller, configured to:
determine that a first nonvolatile memory medium of a first RAID is not operable to be utilized in the first RAID;
provide, to another RAID controller via a Peripheral Component Interconnect Express (PCIe) protocol, a request for at least a second nonvolatile memory medium of a second RAID has a amount of data storage that is operable to be utilized in the first RAID;
access, via the PCIe protocol and the other RAID controller, the amount of data storage of the second nonvolatile memory medium;
rebuild the first RAID with the amount of data storage of the second nonvolatile memory medium;
receive file information from an operating system to store via the first RAID;
store, via the PCIe protocol and the other RAID controller, at least a first portion of the file information to the second nonvolatile memory medium;
receive the at least the first portion of the file information from the other RAID controller via the PCIe protocol; and
provide the file information to the operating system.

18. The RAID controller of claim 17,
wherein the PCIe protocol encapsulates a vendor defined message protocol; and
wherein, to receive the at least the first portion of the file information from the other RAID controller via the PCIe protocol, the RAID controller is further configured to receive the at least the first portion of the file information from the other RAID controller via the vendor defined message protocol.

19. The RAID controller of claim 17, wherein the RAID controller is further configured to:
determine that a third nonvolatile memory medium has been added to the first RAID;
rebuild the first RAID with the third nonvolatile memory medium; and
provide deallocation information to the other RAID controller via the PCIe protocol to indicate that the amount of data storage is no longer needed.

20. The RAID controller of claim 1, wherein the RAID controller is further configured to recognize, via the PCIe protocol, the amount of data storage from the other RAID controller as a virtual drive.
